(19) United States
(12) Patent Application Publication
(10) Pub. No.: US 2013/0141279 A1
(43) Pub. Date: Jun. 6, 2013

(54) POSITIONING SATELLITE SIGNAL RECEIVER, POSITIONING SATELLITE SIGNAL RECEIVING METHOD, AND COMPUTER READABLE STORAGE MEDIUM

(71) Applicant: Denso Corporation, Kariya-city (JP)

(72) Inventor: Mitsuru SUZUKI, Ichinomiya-city (JP)

(73) Assignee: DENSO CORPORATION, Kariya-city (JP)

(21) Appl. No.: 13/688,681

(22) Filed: Nov. 29, 2012

(30) Foreign Application Priority Data
Dec. 1, 2011 (JP) 2011-263874

(51) Int. Cl. G01S 19/24

(52) U.S. Cl. CPC G01S 19/24
USPC 342/357.63

(57) ABSTRACT

A positioning signal receiver is disclosed. The receiver stores a correction table indicating a correspondence between a predetermined temperature and a drift amount of a frequency of a reference signal outputted from an oscillator unmounted in the receiver when the oscillator unmounted in the receiver has the predetermined temperature. The receiver further stores a specified frequency that is the frequency of the reference signal outputted from the oscillator incorporated into the receiver and having a specified temperature. The receiver estimates a drift amount of the frequency of the reference signal outputted from the oscillator incorporated into the receiver, based on a temperature data detected with a temperature sensor, the stored correction table and the stored specified frequency.

### CROSS REFERENCE TO RELATED APPLICATION

The present application is based on Japanese Patent Application No. 2011-263874 filed on Dec. 1, 2011, disclosure of which is incorporated herein by reference.

### TECHNICAL FIELD

The present disclosure relates to a positioning satellite signal receiver, a method for receiving a positioning satellite signal, a non-transitory computer readable storage medium.

### BACKGROUND

A global positioning system (GPS) uses positioning signals transmitted from multiple low-orbit satellites orbiting around the earth, which may be 24 satellites. A GPS receiver receives the positioning signals from at least three satellites, demodulates informations contained in respective positioning signals, and analyzes the information obtained by the demodulation, thereby positioning the present position of the receiver.

A typical receiver includes an oscillator for outputting a reference frequency signal used for down-converting the positioning signal. A frequency of the reference frequency signal changes (drifts) according to temperatures of the oscillator and peripheral parts. Because of this, a correction table associating between a frequency drift amount of the reference frequency signal and a temperature data measured with a temperature sensor is prepared. Based on the correction table and the temperature data, a correction to the reference frequency signal is made (refer to, for example, Patent Document 1).

Patent Document 1: Japanese Patent No. 2921435.

However, even under the same condition, the drift amount of the reference frequency signal differs from oscillator to oscillator. Additionally, it is known that this drift amount changes under influences of peripheral parts of the oscillator and a board mounted with the oscillator. Even under the same condition, the drift amount caused by the peripheral part differs from peripheral part to peripheral part, and the drift amount caused by the board differs from board to board. Because of these, when a table-type correction method, in which a correction value of the reference frequency signal is set for each predetermined temperature range, is employed, a process for acquiring the correction value needs to be preformed on a receiver-by-receiver basis. Thus, a time taken to manufacture and test a receiver is long, and, the manufacturing efficiency is low.

Specifically, after assembling the receiver (product) it is necessary to measure, on a receiver-by-receiver basis, the drift amount of the reference frequency signal at given temperatures in a predetermined temperature range and record the correction data of the drift amount in the receiver. In other words, for every receiver (all the receivers), it is necessary to acquire the correction data of the drift amount and records the correction data. This reduces the manufacturing efficiency.

### SUMMARY

In view of the foregoing, it is an object of the present disclosure to provide a positioning satellite signal receiver, a positioning satellite signal receiving method and a non-transitory computer readable storage medium that can reduce a receiver manufacturing cost by reducing the number of manufacturing processes that are performed for correcting drift amounts of reference frequency signals of receivers.

According to a first example, a receiver for receiving a positioning satellite signal from a positioning satellite is provided. The receiver comprises an oscillator, a temperature sensor, a correction table storage, a frequency storage, and a processor.

The oscillator outputs a reference frequency signal used for down-converting the positioning satellite signal. The temperature sensor detects temperature of the oscillator and provides a temperature data. The correction table storage stores a correction table indicating a correspondence between a predetermined temperature and a drift amount of a frequency of the reference frequency signal outputted from the oscillator unmounted in the receiver. The drift amount stored in the correction table storage is an amount of change of a first frequency with respect to a second frequency. The first frequency is the frequency of the reference frequency signal that is outputted from the oscillator unmounted in the receiver when the oscillator unmounted in the receiver has the predetermined temperature. The second frequency is the frequency of the reference frequency signal outputted from the oscillator unmounted in the receiver when the oscillator unmounted in the receiver has a reference temperature. The frequency storage stores a specified frequency, wherein the specified frequency is the frequency of the reference frequency signal that is outputted from the oscillator incorporated into the receiver when the oscillator incorporated into the receiver has a specified temperature. The processor estimates a drift amount of the frequency of the reference frequency signal outputted from the oscillator incorporated into the receiver, based on the temperature data detected with the temperature sensor, the correction table stored in the correction table storage, and the specified frequency stored in the frequency storage. Based on the estimated drift amount, the processor calculates the frequency of the reference frequency signal outputted from the oscillator incorporated into the receiver.

According to a second example, a positioning satellite signal receiving method for use in a receiver that receives a positioning satellite signal transmitted from a positioning satellite and down-converts the received positioning satellite signal by using a reference frequency signal outputted form an oscillator is provided. The positioning satellite signal receiving method comprises estimating a drift amount of a frequency of the reference frequency signal outputted form the oscillator incorporated into the receiver, based on a temperature data, a correction table and a specified frequency. The temperature data is outputted from a temperature sensor detecting temperature of the oscillator. The correction table indicates a correspondence between a predetermined temperature and a drift amount of the frequency of the reference frequency signal outputted from the oscillator unmounted in the receiver, wherein the drift amount of the frequency of the reference frequency signal outputted from the oscillator unmounted in the receiver is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature. The specified frequency is the frequency of the reference frequency signal that is outputted from the oscillator incorporated into the receiver when the oscillator incorporated into the receiver has a specified temperature. The positioning satellite signal receiving method further comprises calculating, based on the estimated drift amount, the frequency of the reference frequency signal outputted from the oscillator incorporated into the receiver.

According to a third example, a non-transitory computer-readable storage medium is provided. The non-transitory computer-readable storage medium stores a program comprising computer-executable instructions that cause a computer of a receiver, which receives a positioning satellite signal transmitted from a positioning satellite, to perform: outputting, by an oscillator, a reference frequency signal used for down-converting the positioning satellite signal; detecting, by a temperature sensor, temperature of the oscillator to provide a temperature data; storing in a correction table storage a correction table indicating a correspondence between a predetermined temperature and a drift amount of a frequency of the reference frequency signal outputted from the oscillator unmounted in the receiver, wherein the drift amount stored in the correction table storage is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature; storing in a frequency storage a specified frequency that is the frequency of the reference frequency signal that is outputted from the oscillator incorporated into the receiver when the oscillator incorporated into the receiver has a specified temperature; estimating, by a processor, a drift amount of the frequency of the reference frequency signal outputted from the oscillator incorporated into the receiver, based on the temperature data detected with the temperature sensor, the correction table stored in the correction table storage, and the specified frequency stored in the frequency storage; and calculating, by the processor, the frequency of the reference frequency signal outputted from the oscillator incorporated into the receiver, based on the estimated drift amount.

According to the above receiver, the above method, and the above non-transitory computer readable storage medium, the frequency drift amount of the reference frequency signal outputted at a time of temperature detection from the oscillator incorporated in the receiver can be obtained based on the correction table, the specified temperature and the temperature data. Thus, by performing processing on the received positioning satellite signal by using the frequency drift amount at the time of temperature detection, it is possible to reduce a time taken to capture the positioning signal. In other words, it becomes possible to capture the positioning signal in a short period of time. Furthermore, efficiency in testing the receiver during manufacturing the receiver can be improved because the correction table indicative of the correspondence between the frequency drift amount of the reference frequency signal of the oscillator unmounted in the receiver and the temperature of the oscillator unmounted in the receiver is separately treated from the data of the temperature (temperature data) of the oscillator incorporated into the receiver. That is, by making the correction table for the oscillator unmounted in the receiver before the oscillator is incorporated into the receiver, it is possible to eliminate a process of making the correction table in manufacturing the receiver, and it is possible to simplify a testing process. It should be noted that the specified temperature and the reference temperature may be the same temperature or different temperatures.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a positioning satellite signal receiver of one embodiment;

FIG. 2 is a graph illustrating frequency tolerance of an unmounted crystal oscillator;

FIG. 3 is a graph illustrating ac a characteristic curve of frequency drift amount of a crystal oscillator device mounted to a board;

FIG. 4 is a graph illustrating a deviation of frequency drift amount of a crystal oscillator device mounted to a board when an offset value φ is set;

FIG. 5 is a flowchart illustrating a testing of a receiver according to comparison example;

FIG. 6 is a flowchart illustrating a testing of a receiver according to one embodiment; and

FIG. 7 is a flowchart illustrating a search process performed by a receiver to capture a positioning signal.

### DETAILED DESCRIPTION

Embodiments will be described with reference to the drawings.

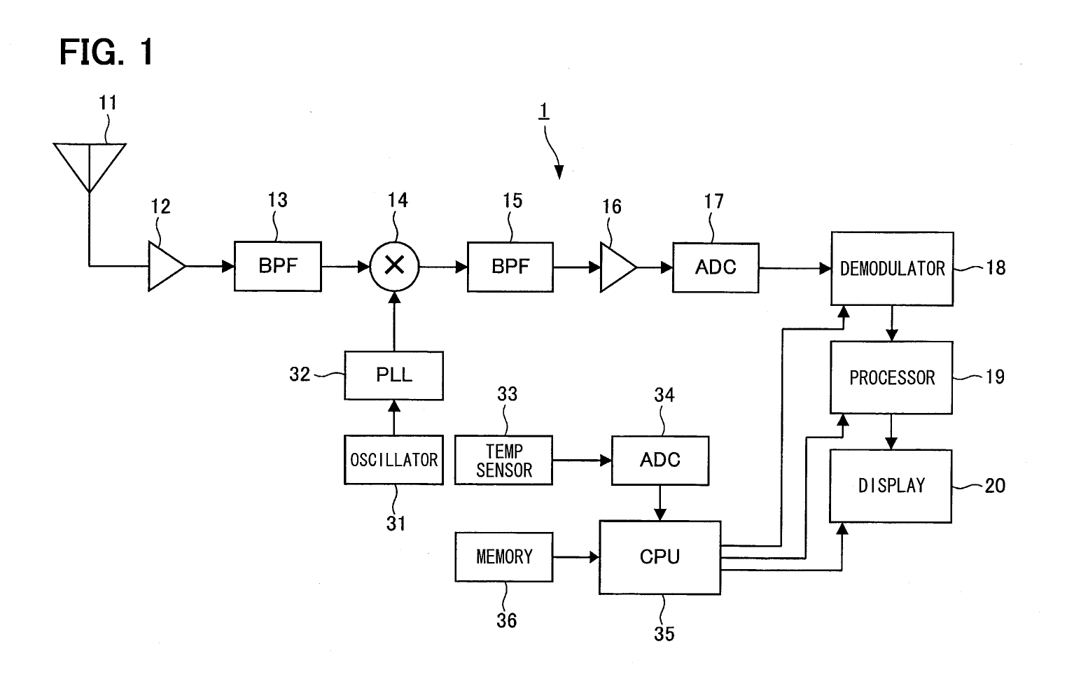

A positioning satellite signal receiver 1 (also refereed to as receiver) of one embodiment will be illustrated with reference to FIGS. 1 to 7. In this embodiment, the receiver 1 is applied to a positioning system that uses artificial satellites (positioning satellite), which may be the GPS satellites. In the present embodiment, the receiver 1 positions its present position by receiving positioning signals (positioning satellite signal) from multiple artificial satellites, demodulating informations contained in respective positioning signals, and analyzing the informations obtained by the demodulation. In the above, the positioning signals transmitted from artificial satellites are spread-spectrum signals.

As shown in FIG. 1, the receiver 1 includes an antenna 11, an amplifier 12, a band pass filter 13 (also referred to as BPF 13), a mixer 14, a phase-locked loop circuit 32 (also referred to as PLL circuit 32), a band pass filter 15 (also referred to as BPF 15), an amplifier 16, an analog/digital converter 17, a demodulator 18, and a computation unit 19 (also called processing unit 19). The demodulator 18 may correspond to a processor, and processing means.

The antenna 11 receives the positioning signal from the artificial satellite. The antenna 11 is communicably connected to the amplifier 12, so that the antenna 11 can transmit the received positioning signal (also referred to as received signal) to the amplifier 12. The amplifier 12 amplifies the received signal and provides the amplified received signal to the mixer 14 via the BPF 13. The mixer 14 mixes the amplified received signal with a frequency signal outputted from the PLL circuit 32, and performs frequency-conversion to convert the received signal with a predetermined frequency (e.g., 1.5 GHz band) into an intermediate frequency signal.

The frequency signal outputted from the PLL circuit 32 is generated in the following way. The crystal oscillator device 31, which may correspond to an oscillator and oscillating means, outputs a constant frequency signal having a substantially constant frequency. This constant frequency signal may correspond to a reference frequency signal. A frequency divider (not shown) of the PLL circuit 32 performs frequency division on the constant frequency signal outputted from the crystal oscillator device 31, thereby generating the frequency signal, which is outputted from the PLL circuit 32. A frequency of the signal outputted from the PLL circuit 32 (also referred to as oscillating frequency) can be changed by controlling, for example, a dividing ratio of the frequency divider or the like. The oscillating frequency is controlled by a central processing unit (CPU) 35.

The intermediate frequency signal outputted from the mixer 14 is supplied to the demodulator 18 via the BPF 15 and the amplifier 16. The demodulator 18 performs a demodulation process of the GPS positioning signal. The demodulator 18 performs an inverse spread-spectrum process by multiplying the intermediate frequency signal by a pseudo-noise code (PN code, also called a pseudo-random code), and performs the demodulation process of a transmission data by phase-shift keying (PSK) demodulation of the inverse-spread-spectrum-processed signal. Through the above demodulation process, it is possible to obtain a time data (time information), an orbit data and the like transmitted from the artificial satellite. Data such as the time data, the orbit data and the like transmitted from the artificial satellite is referred to herein as the transmission data.

The PN code used in the inverse spread-spectrum process is designated on an artificial-satellite-by-artificial-satellite basis. By selecting the PN code, it is possible to select an artificial satellite from which the positioning signal is received. Selecting the artificial satellite from which the positioning signal is received, in other words, selecting the PN code, is controlled by the central processing unit 35 (also referred to as CPU 35). The CPU 35 is a microcomputer and controls a receipt operation of the receiver 1. The CPU 35 determines whether or not the positioning signal transmitted from a desired (target) artificial satellite has been successfully captured.

The demodulator 18 can simultaneously perform multiple demodulation processes. For example, the demodulator 18 can simultaneously perform 8-channel demodulation processes. Thus, the demodulator 18 can perform the demodulation processes on positioning signals received during a same time period from multiple artificial satellites. There may be various kinds of configuration for simultaneously performing the multiple demodulation processes. In one configuration, the demodulator 18 may be provided with demodulation circuits, the number of which is the same as the number of simultaneously-performed demodulation processes. In another configuration, the demodulator 18 may be provided with demodulation circuits, the number of which is smaller than the number of simultaneously-performed demodulation processes. In this case, the demodulation processes may be performed in a time-division manner, so that the demodulation processes, the number of which is larger than the number of demodulation circuits, are simultaneously performed.

The multiple transmission data of respective artificial satellites, which are obtained by the demodulation processes, are sent from the demodulator 18 to the processing unit 19. Accordingly, the processing unit 19 performs the following process. The processing unit 19 determines the orbit of the artificial satellite indicated by the transmission data, and determines a propagation time of the positioning signal transmitted from the artificial satellite. In the above, the propagation time is determined based on a phase of the PN code generated at a time of the inverse-spread spectrum. Thereafter, the processing unit 19 performs a process of calculating the present position of the receiver 1, in other words, performs a positioning process by using the determined orbit of the artificial satellite and the determined propagation time,

The process of calculating the present position will be more specifically illustrated. An assumed situation is that the positioning signals transmitted from, for example, four artificial satellites, are simultaneously captured. First, the receiver 1 performs a process of calculating position informations of the four artificial satellites at a certain time based on, for example, the orbit data obtained from the received positioning signals, or the like. Then, the receiver 1 performs a process of obtaining distance data between the calculated positions of the artificial satellites and the present position (positioned point) of the receiver 1 from propagation delays based on the above propagation times. Thereafter, the receiver 1 obtains the present position of the receiver 1 by solving simultaneous equations with four unknowns. The simultaneous equations are given from the position data of the four artificial satellites and the distance data.

A data of the calculated present position of the receiver 1 is transmitted to the display device 20 and displayed on the display device 20 in a predetermined form. For example, latitude, longitude and altitude of the present position may be displayed. Additionally, when the receiver 1 is used for a navigation apparatus, the calculated present position and a map around the present position may be displayed on the display device 20.

A temperature sensor 33 for detecting temperature of the crystal oscillator device 31 is disposed in the vicinity of the crystal oscillator device 31. The temperature sensor 33 may correspond to a temperature sensing means. To an analog/digital converter 34, the temperature detected by the temperature sensor 33 is outputted as a temperature data in the form of voltage whose electric potential changes in proportion to the temperature. The analog/digital converter 34 converts the temperature data from an analog data whose electric potential (voltage) continuously changes into a digital data whose electric pontifical (voltage) discretely changes. Thereafter, the analog/digital converter 34 outputs the converted temperature data, which is a digital data, to the CPU 35.

The CPU 35 is provided with a memory 36. The memory 36 stores a correction table and an offset amount data. The correction table includes a temperature tolerance data of an amount of frequency drift caused by a cut angle (cut angle data) of a crystal oscillator used in the crystal oscillator device 31. The offset amount data includes a data of the amount of frequency drift. The memory 36 may correspond to a correction table storage, a frequency storage, a correction table storing means, and a frequency storing means.

In capturing the positioning signals transmitted from the artificial satellites, the following process is performed. A frequency range used in a process at a time of the capturing is set based on (i) the temperature data outputted from the temperature sensor 33 at the time of the capturing, (ii) the correction table stored in the memory 36, and (ii) the offset amount data.

In the following, estimation of the frequency drift amount will be described. Specifically, a frequency drift amount estimation process, which is performed based on the offset amount data and the correction table, will be described in detail. The frequency drift amount is an amount of change in frequency of a first signal with respect to a second signal. In the above, the first signal is a signal outputted from an unmounted crystal oscillator device 31 having a predetermined temperature. The second signal is a signal outputted from the unmounted crystal oscillator device 31 having a reference temperature. The unmounted crystal oscillator device 31 is the crystal oscillator device 31 that is unmounted in the receiver.

It is known that the frequency drift amount of an unmounted crystal oscillator used in the crystal oscillator device can be approximated as the following equation:

(expression 1)

Δf/f=αT+βT²+γT³+φ Eq. (1)

where f is frequency and T is temperature.

Additionally, it is known that factors α, β, γ in Eq. (1) is determined based on the cut angle of a crystal piece serving as the crystal oscillator.

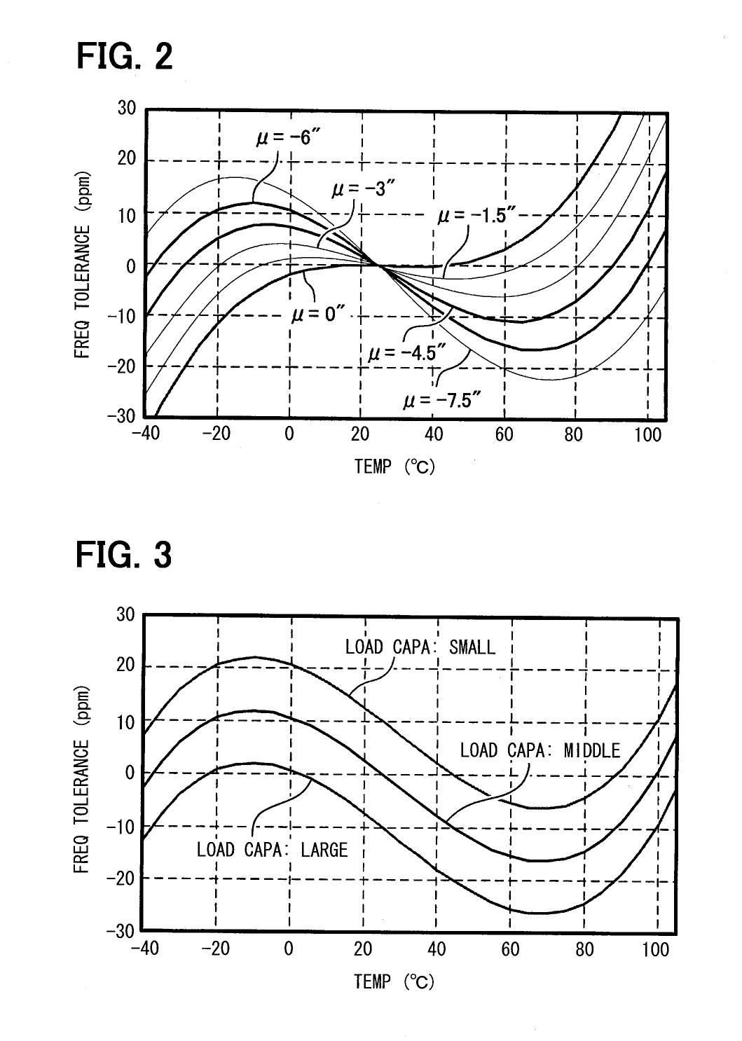

FIG. 2 is a graph illustrating a frequency drift amount (frequency tolerance (ppm)) of a single crystal oscillator as a function of temperature of the crystal oscillator. FIG. 2 illustrates how the frequency drift amount of an unmounted crystal oscillator changes with the cut angle of the crystal oscillator.

Here, it has been unknown whether, when the crystal oscillator device 31 is mounted to a board, a load capacitance of the board and a peripheral part mounted around the crystal oscillator device 31 causes distortion (see FIG. 2) or offset of a characteristic curve of the oscillating frequency drift amount of the signal that is outputted from the crystal oscillator device 31 through the board. That is, it has been unknown whether the distortion occurs or the offset occurs.

Because of the above, a study on an influence of the load capacitance on the characteristic curve of the oscillating frequency drift amount has been made. In the study, the load capacitances of the board and the peripheral part were changed while the same crystal oscillator device 31 was being used.

As a result of this study, it is revealed that, as shown in FIG. 3, in a range between −40 degrees C. and 105 degrees C., in response to the change in load capacitance of the board or the peripheral part, only an offset amount of the characteristic curve of the oscillating frequency drift amount of the signal, which is outputted from the crystal oscillator device 31 through the board, changes. In the above, the range between −40 degrees C. and 105 degrees C. may be a service condition of the receiver 1. In other words, the distortion of the characteristic curve of the oscillating frequency drift amount in response to the change in load capacitance of the board or the peripheral part was not observed.

Therefore, when the crystal oscillator device 31 is mounted to the board, it is possible to obtain the oscillating frequency drift amount of the crystal piece of the mounted crystal oscillator device 31 at each temperature if the cut angle μ of the crystal piece of the crystal oscillator device 31 and the above-described offset φ are known

In the present embodiment, a shape variation of the crystal piece of the crystal oscillator device 31 at a manufacturing process is restricted within a certain range (certain limit), so that the cut angle μ is represented by a representative value μ_{typ}. Furthermore, the frequency drift amount of the unmounted crystal oscillator device 31 at an arbitrary one temperature is measured, and the offset φ is obtained using the above equation (1). The frequency drift amount of the unmounted crystal oscillator device 31 at an arbitrary one temperature is a specified temperature.

(expression 2)

Δf/f_{typ}=α_{typ}T+β_{typ}T²+γ_{typ}T³+φ_{typ} Eq. (2)

The successful-capturing of the positioning signal from the artificial satellite in the capturing process and the successful-positioning of the present position of the receiver 1 make it possible to detect the oscillating frequency drift amount. In the case of the GPS of the present embodiment, the successful-positioning of the present position of the receiver 1 makes it possible to accurately obtain the oscillating frequency of the crystal oscillator device 31 by performing a predetermined calculation. A data about a difference between the accurately-obtained oscillation frequency and a predetermined frequency at which the crystal oscillator device 31 is predetermined to oscillate provides the oscillating frequency drift amount.

The oscillating frequency drift amount can be obtained using the positioning signal transmitted from an actual artificial satellite, as described above. Alternatively, the oscillating frequency drift amount may be obtained using a pseudo positioning signal generated by a GPS simulator. That is, a manner of obtaining the oscillating frequency drift amount is not limited.

When the GPS simulator is used, the oscillating frequency of the positioning signal outputted from the GPS simulator is accurately obtainable, and thus, the positioning using the positioning signals outputted from the multiple artificial satellites becomes unnecessary. In this case, a data of a difference between the frequency at the time of capturing the positioning signal in the capturing process and the predetermined frequency at which crystal oscillator device 31 is predetermined to oscillate provides the oscillating frequency drift amount.

As described above, the shape variation of the crystal piece of the crystal oscillator device 31 at a manufacturing process is restricted within a certain range (certain limit), so that the cut angle μ can be represented by a representative value μ_{typ}. However, a variation in cut angle μ, which cannot be restricted within a certain range (certain limit) by crystal piece selection, may appear as an error between an estimated value and an actual value of the frequency drift amount.

When a degree of the variation in cut angle μ is known beforehand, the error of the frequency drift amount can be obtained based on the equation (1) in the following way. That is, when an upper limit of the variation in cut angle μ is denoted by μₘₐₓ and a lower limit of the variation in cut angle μ is denoted by μₘᵢₙ, the following expression can be obtained.

(expression 3)

upper limit: Δf/fₘₐₓ=αₘₐₓT+βₘₐₓT²+γₘₐₓT³+φₘₐₓ Eq. (3)

lower limit: Δf/fₘᵢₙ=αₘᵢₙT+βₘᵢₙT²+γₘᵢₙT³+φₘᵢₙ Eq. (4)

Accordingly, the error of the frequency drift amount at any temperature, which error is caused by the variation in cut angle μ, can be expressed as:

upper limit side error: Δf/f=Eq. (3)−Eq. (2)

lower limit side error: Δf/f=Eq. (4)−Eq. (2) (expression 4)

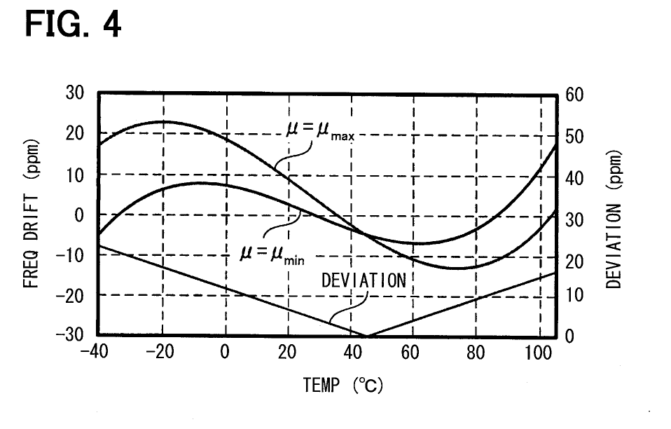

Here, the deviation of the frequency drift amount at each temperature will be described with reference to FIG. 4. The frequency drift amount in FIG. 4 is the frequency drift amount when the offset value φ was determined based on a result of the measurement of the crystal oscillator device 31 having the temperature of 45 degrees C. In FIG. 4, since the temperature of the crystal oscillator device 31 at a time when the offset φ was determined is 45 degrees C., the deviation of frequency drift amount at 45 degrees C. is zero. The temperature of the crystal oscillator device 31 when the offset φ was determined is also refereed to as a measurement temperature. As shown in FIG.4, as the temperature of the crystal oscillator device 31 departs from the measurement temperature, the frequency drift amount increases because of the influence of the cut angle φ. In other words, a difference between the curve μ=μₘₐₓ and the curve μ=μₘᵢₙ in FIG. 4 becomes larger as the temperature of the crystal oscillator device 31 departs from the measurement temperature.

In an actual use of the receiver 1, the following processing may be performed; the deviation of frequency drift amount is obtained based on the measurement temperature of the crystal oscillator device 31 and the graph like that shown in FIG. 4; and the search range in the capturing process is increased by the obtained deviation.

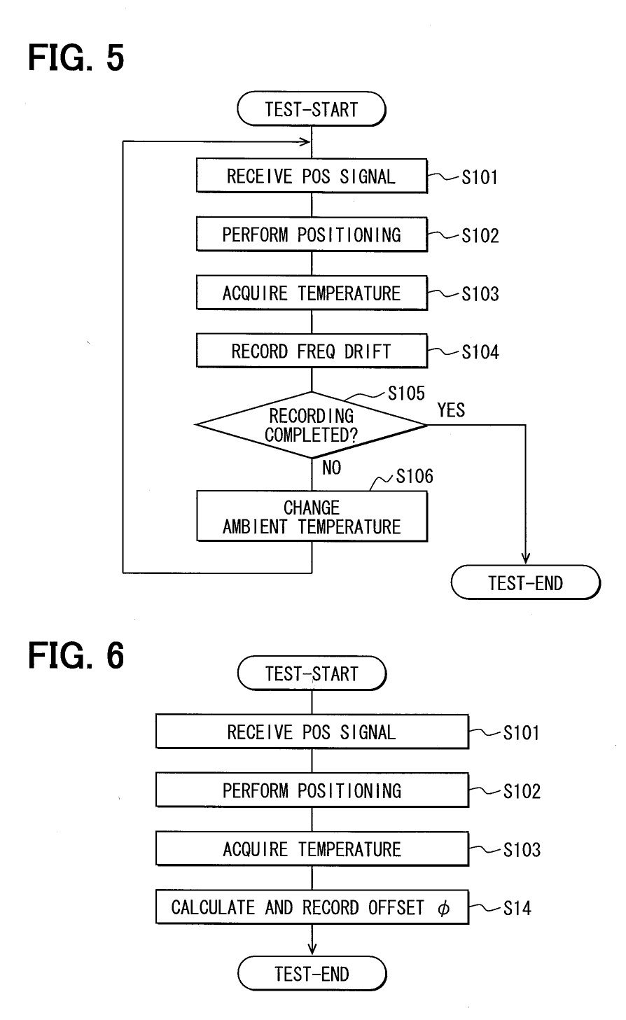

Next, a processing for recording the frequency drift amount in the receiver will be described with reference to FIG. 5 in accordance with a comparison example. This processing is performed in testing the receiver.

When the testing is started, a receipt process is performed at S101. In the receipt process, the receiver receives the positioning signal transmitted from an actual artificial satellite or the positioning signal generated by a signal generator (GS) such as a GPS simulator or the like.

At S102, a positioning process is performed. Specifically, the receiver 1 calculates the present position of the receiver based on the received positioning signal.

At S103, a temperature data acquisition process is performed. In the temperature data acquisition process, the temperature of the crystal oscillator device during the above positioning process is measured with the temperature sensor, and the temperature data outputted from the temperature sensor is acquired.

At S104, a recording process is preformed. In the recording process, the frequency drift amount of the crystal oscillator device obtained from the positioning process at S102 is recorded as a data of the frequency drift amount at one of set temperatures closest to the temperature acquired at S103.

At S105, it is determined whether or not the recording process has been performed for all of the set temperatures. In other words, it is determined whether or not the recording process at S104 has been completed. In the above, the set temperature are preset temperatures. When it is determined that the recording process has been performed for all of the set temperatures (YES at S105), the testing is ended.

When it is determined that the recording process has not been performed for all of the set temperatures (NO at S105), S106 is performed.

At S106, an ambient temperature of the crystal oscillator device or an ambient temperature of the receiver is changed, so that the temperature of the crystal oscillator device becomes the set temperature at which the recording process at S104 has not been performed. Thereafter, the processing returns to S101, and S101 to S104 are repeated until the recording process is performed for all of the set temperatures.

For example, the receiver is put in an inside of a thermostatic bath. While the temperature of the inside of the thermostatic bath is being kept one set temperature, S101 to S104 are performed. This is in turn performed in an order of increasing temperature from a low set temperature to a high temperature. In the above, while the receiver is receiving the positioning signal, only the positioning process may be repeated at different temperatures.

Next, a processing for recording the frequency drift amount in the receiver 1 will be described with reference to FIG. 6 in accordance with one embodiment. This processing is performed in testing the receiver 1. After the testing is started, S101 to S103 are performed. The receipt process at S101 for receiving the positioning signal, the positioning process at S102 for performing the positioning, and the temperature data acquisition process at S103 for acquiring the temperature data in FIG. 6 are the same as those in FIG. 5.

After the temperature data acquisition process at S103 is performed, a recording process is performed at S14. In the recording process, the process of calculating the offset amount φ at an arbitrary one temperature (specified temperature) of the crystal oscillator device 31 and the process of recording the calculated offset amount φ in the memory 36 are performed.

Additionally, the correction table indicative of the frequency drift amount at multiple set temperatures is recorded in the memory 36 by performing substantially the same process as that at S104. It should be noted that the process of calculating the offset amount φ has been described in detail in the above.

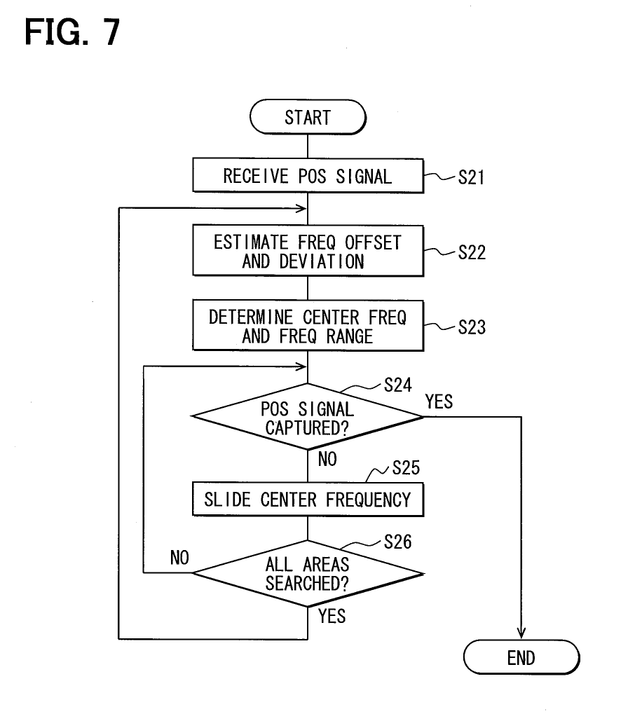

The process of capturing (also called the search process) the positioning signal transmitted from the artificial satellite will be described with reference to FIG. 7. Note that this capturing process is performed by the receiver 1. First, at S21, a receipt process is performed. In the receipt process, the positioning signal transmitted from the artificial satellite is received. At S22, based on the temperature data outputted from the temperature sensor 33, the CPU 35 of the receiver 1 calculates the temperature of the crystal oscillator device 31 at the present time, and performs the processing for estimating the offset amount and deviation of the oscillating frequency of the crystal oscillator device 31.

Thereafter, at S23, the CPU 35 performs the process of increasing the search range of the positioning signal. For example, the CPU 35 may cause the demodulator 18 to perform, as a part of the demodulation process, the process of increasing the search range of the positioning signal. More specifically, the demodulator 18 may perform the process of shifting the center frequency of the search frequency range by the offset amount, and performs the process of increasing the search frequency range by the deviation amount. After increasing the search range, the demodulator 18 performs the process of capturing the positioning signal by slightly changing (increasing and decreasing) the frequency with which the demodulation process is performed.

At S24, a determination process is performed. In the determination process, it is determined whether or not the positioning signal transmitted from the artificial satellite has been successfully captured. In other words, in the determination process, it is determined whether or not the positioning signal has been successfully demodulated by the demodulator 18. When it is determined that the positioning signal has been successfully captured (YES at S24), a process of continuing to receive the positioning signal by using the frequency that was used at the capturing is performed, and thereafter, the capturing process of the positioning signal is ended.

When it is determined that the positioning signal has not been successfully captured (NO at S24), the processing proceeds to S25. At S25, a process of sliding the search range of the positioning signal is performed. This process is a part of the demodulation process. Specifically, a process of sliding the center frequency of the search frequency range is performed.

After the search range is slid, a determination process is performed at S26. In this determination process, it is determined whether or not the capturing process (search) has been performed for all of frequency ranges (all of areas) that are set to detect the positioning signal. When it is determined that the search has not been made for all of the areas (NO at S26), the processing is return to S24.

When it is determined that the search has been made for all of the areas (YES at S26), the processing is return to S22 to again estimate the offset amount and deviation of the oscillating frequency based on the temperature data outputted from the temperature sensor 33.

According to the above configuration of the receiver 1, when the crystal oscillator device 31 is incorporated into the receiver 1, the oscillating drift amount of the crystal oscillator device 31 at the time of temperature detection can be obtained based on the correction table, the offset amount φ and the temperature data. By performing the capturing process of the positioning signal by using this oscillating drift amount at the time of temperature detection, it is possible to shorten a time taken to capture the positioning signal. In other words, it is possible to capture the positioning signal in a short amount of time.

Moreover, since the correction table indicative of the correspondence between the frequency drift amount of the crystal oscillator device 31 unmounted in the receiver 1 and the temperature can be treated separately from the temperature data of the crystal oscillator device 31 incorporated into the receiver 1, the testing performed during manufacturing the receiver 1 can be highly-efficiently performed. In other words, by making the correction table for the crystal oscillator device 31 unmounted in the receiver 1 before the crystal oscillator device 31 is incorporated into the receiver 1, the process of making the correction table in the manufacturing the receiver 1 can be eliminated, and the testing process can be simplified.

In the present embodiment, the crystal oscillator serves as the crystal oscillator device. The correction table can be uniquely determined based on a function of the cut angle μ of the crystal oscillator and the variation in cut angle μ. In order to determine the correction table, it is sufficient to retain a data of only the function of the cut angle μ of the crystal oscillator and the variation in cut angle μ. Therefore, it is possible to remarkably reduce an amount of data stored in the memory 36, as compared with cases where all of the data of the frequency drift amounts at multiple predetermined temperatures are stored.

For the correction table, the present embodiment uses a cut angle representing the multiple crystal oscillator devices 31 and its variation, instead of using a cut angle of each crystal oscillator device 31 and its variation on a crystal-oscillator-device-by-crystal-oscillator-device basis. Thus, it is unnecessary to make the correction table on a crystal-oscillator-device-by-crystal-oscillator-device basis, and it is possible improve manufacturing efficiency of the receiver 1. The correction table usable for multiple crystal oscillators 31 may be, for example, a correction table that uses a cut angle μ representing the same kind of crystal oscillator devices 31, and its variation. Alternatively, when the cut angles μ representing the same kind of crystal oscillator devices 31 and the variation in cut angle μ can be classified into multiple ranks, the correction table may be selected from multiple correction tables that respectively correspond to the multiple ranks.

Moreover, since the variation in cut angle μ is defined in the correction table, the reference frequency signal calculated in the demodulator 18 can be generated as a signal with a predetermined range frequency band based on the variation in cut angle μ. Thus, with wide frequency latitude, it is possible to perform the capturing process of the positioning signal, and it is possible to reliably capture the positioning signal.

The demodulator 18 can correspond to an example of a processor and an example of a processing means. The crystal oscillator device 31 can correspond to an example of an oscillator and an example of an oscillating means. The temperature sensor 33 can correspond to an example of a temperature sensing means. The memory 36 can correspond to an example of a correction table storage, an example of a frequency storage, an example of a correction table storing means, and an example of a frequency storing means.

According embodiments of the present disclosure, a positioning satellite signal receiver, a positioning satellite signal receiving method and a non-transitory computer readable storage medium can be provided in various forms.

According to a first example, a receiver for receiving a positioning satellite signal from a positioning satellite is provided. The receiver comprises an oscillator, a temperature sensor, a correction table storage, a frequency storage, and a processor. The oscillator outputs a reference frequency signal used for down-converting the positioning satellite signal. The temperature sensor detects temperature of the oscillator and provides a temperature data. The correction table storage stores a correction table indicating a correspondence between a predetermined temperature and a drift amount of a frequency of the reference frequency signal outputted from the oscillator unmounted in the receiver. The drift amount stored in the correction table storage is an amount of change of a first frequency with respect to a second frequency. The first frequency is the frequency of the reference frequency signal that is outputted from the oscillator unmounted in the receiver when the oscillator unmounted in the receiver has the predetermined temperature. The second frequency is the frequency of the reference frequency signal outputted from the oscillator unmounted in the receiver when the oscillator unmounted in the receiver has a reference temperature. The frequency storage stores a specified frequency, wherein the specified frequency is the frequency of the reference frequency signal that is outputted from the oscillator incorporated into the receiver when the oscillator incorporated into the receiver has a specified temperature. The processor estimates a drift amount of the frequency of the reference frequency signal outputted from the oscillator incorporated into the receiver, based on the temperature data detected with the temperature sensor, the correction table stored in the correction table storage, and the specified frequency stored in the frequency storage. Based on the estimated drift amount, the processor calculates the frequency of the reference frequency signal outputted from the oscillator incorporated into the receiver.

According to a second example, a positioning satellite signal receiving method for use in a receiver that receives a positioning satellite signal transmitted from a positioning satellite and down-converts the received positioning satellite signal by using a reference frequency signal outputted form an oscillator is provided. The positioning satellite signal receiving method comprises estimating a drift amount of a frequency of the reference frequency signal outputted form the oscillator incorporated into the receiver, based on a temperature data, a correction table and a specified frequency. The temperature data is outputted from a temperature sensor detecting temperature of the oscillator. The correction table indicates a correspondence between a predetermined temperature and a drift amount of the frequency of the reference frequency signal outputted from the oscillator unmounted in the receiver, wherein the drift amount of the frequency of the reference frequency signal outputted from the oscillator unmounted in the receiver is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature. The specified frequency is the frequency of the reference frequency signal that is outputted from the oscillator incorporated into the receiver when the oscillator incorporated into the receiver has a specified temperature. The positioning satellite signal receiving method further comprises calculating, based on the estimated drift amount, the frequency of the reference frequency signal outputted from the oscillator incorporated into the receiver.

According to a third example, a non-transitory computer-readable storage medium is provided. The non-transitory computer-readable storage medium stores a program comprising computer-executable instructions that cause a computer of a receiver, which receives a positioning satellite signal transmitted from a positioning satellite, to perform: outputting, by an oscillator, a reference frequency signal used for down-converting the positioning satellite signal; detecting, by a temperature sensor, temperature of the oscillator to provide a temperature data; storing in a correction table storage a correction table indicating a correspondence between a predetermined temperature and a drift amount of a frequency of the reference frequency signal outputted from the oscillator unmounted in the receiver, wherein the drift amount stored in the correction table storage is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature; storing in a frequency storage a specified frequency that is the frequency of the reference frequency signal that is outputted from the oscillator incorporated into the receiver when the oscillator incorporated into the receiver has a specified temperature; estimating, by a processor, a drift amount of the frequency of the reference frequency signal outputted from the oscillator incorporated into the receiver, based on the temperature data detected with the temperature sensor, the correction table stored in the correction table storage, and the specified frequency stored in the frequency storage; and calculating, by the processor, the frequency of the reference frequency signal outputted from the oscillator incorporated into the receiver, based on the estimated drift amount.

According to the above receiver, the above method, and the above non-transitory computer readable storage medium, the frequency drift amount of the reference frequency signal outputted at a time of temperature detection from the oscillator incorporated in the receiver can be obtained based on the correction table, the specified temperature and the temperature data. Thus, by performing processing on the received positioning satellite signal by using the frequency drift amount at the time of temperature detection, it is possible to reduce a time taken to capture the positioning signal. In other words, it becomes possible to capture the positioning signal in a short period of time.

Furthermore, efficiency in testing the receiver during manufacturing the receiver can be improved because the correction table indicative of the correspondence between the frequency drift amount of the reference frequency signal of the oscillator unmounted in the receiver and the temperature of the oscillator unmounted in the receiver is separately treated from the data of the temperature (temperature data) of the oscillator incorporated into the receiver. That is, by making the correction table for the oscillator unmounted in the receiver before the oscillator is incorporated into the receiver, it is possible to eliminate a process of making the correction table in manufacturing the receiver, and it is possible to simplify a testing process. It should be noted that the specified temperature and the reference temperature may be the same temperature or different temperatures.

In the above receiver, the above method and the above non-transitory computer readable storage medium, the correction table may not be provided on an oscillator-by-oscillator basis but may be provided as a correction table common to a plurality of the oscillators. As this kind of correction table, the correction table indicative of a characteristic representing multiple oscillators can be used instead of the correction table indicative of a characteristic of a respective oscillator. Thus, it is unnecessary to make the correction table on an oscillator-by-oscillator basis, and it is possible to improve the manufacturing efficiency of the receiver. The correction table usable for multiple oscillators is, for example, the correction table using a characteristic representing the same kind of oscillators. Alternatively, when the characteristics of multiple oscillators can be classified into multiple ranks, the correction table may be selected from multiple correction tables that respectively correspond to the multiple ranks.

In the above receiver, the above method and the above non-transitory computer readable storage medium, the correction table may include a data indicative of deviation of the drift amount under a same condition; and with use of the correction table including the data indicative of the deviation, the frequency of the reference frequency signal outputted from the oscillator incorporated into the receiver may be calculated to be a predetermined range frequency band.

When the correction table is defined in the above way, the reference frequency signal calculated by the processor can be provided as a signal with the predetermined range frequency band that is based on the deviation. Thus, with wide frequency latitude, it is possible to perform the capturing process of the positioning satellite signal, and it is possible to reliably capture the positioning satellite signal.

In the above receiver, the above method and the above non-transitory computer readable storage medium, the oscillator may be a crystal oscillator; and the correction table may be set based on a function of cut angle of the crystal oscillator and a variation of the cut angle.

When the oscillator is a crystal oscillator, the correction table can be uniquely determined based on the function of cut angle of the crystal oscillator and the variation in cut angle. Therefore, in order to determine the correction able, it is sufficient to retain the function of cut angle of the crystal oscillator and the variation in cut angle, and it is possible to remarkably reduce an amount of stored data as compared with cases where a data of drift amounts at multiple predetermined temperatures is stored.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A receiver for receiving a positioning satellite signal from a positioning satellite, comprising:
an oscillator that outputs a reference frequency signal used for down-converting the positioning satellite signal;
a temperature sensor that detects temperature of the oscillator and provides a temperature data;
a correction table storage that stores a correction table indicating a correspondence between
a predetermined temperature and
a drift amount of a frequency of the reference frequency signal outputted from the oscillator unmounted in the receiver, wherein the drift amount stored in the correction table storage is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal outputted from the oscillator unmounted in the receiver when the oscillator unmounted in the receiver has a reference temperature;
a frequency storage that stores a specified frequency, wherein the specified frequency is the frequency of the reference frequency signal that is outputted from the oscillator incorporated into the receiver when the oscillator incorporated into the receiver has a specified temperature; and
a processor that
estimates a drift amount of the frequency of the reference frequency signal outputted from the oscillator incorporated into the receiver, based on the temperature data detected with the temperature sensor, the correction table stored in the correction table storage, and the specified frequency stored in the frequency storage, and
calculates the frequency of the reference frequency signal outputted from the oscillator incorporated into the receiver, based on the estimated drift amount.

2. The receiver according to claim 1, wherein:
the correction table is not provided on an oscillator-by-oscillator basis but is provided as a correction table common to a plurality of the oscillators.

3. The receiver according to claim 1, wherein:
the correction table includes a data indicative of deviation of the drift amount under a same condition; and
by using the correction table including the data indicative of the deviation, the processor calculates, as a frequency band having a predetermined range, the frequency of the reference frequency signal outputted from the oscillator incorporated into the receiver.

4. The receiver according to claim 3, wherein:
the oscillator is a crystal oscillator; and
the correction table is set based on a function of cut angle of the crystal oscillator and a variation of the cut angle.

5. A positioning satellite signal receiving method for use in a receiver that receives a positioning satellite signal transmitted from a positioning satellite and down-converts the received positioning satellite signal by using a reference frequency signal outputted form an oscillator, the positioning satellite signal receiving method comprising:
estimating a drift amount of a frequency of the reference frequency signal outputted form the oscillator incorporated into the receiver, based on:
a temperature data outputted from a temperature sensor detecting temperature of the oscillator;
a correction table indicating a correspondence between
a predetermined temperature and
a drift amount of the frequency of the reference frequency signal outputted from the oscillator unmounted in the receiver, wherein the drift amount of the frequency of the reference frequency signal outputted from the oscillator unmounted in the receiver is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature; and
a specified frequency that is the frequency of the reference frequency signal that is outputted from the oscillator incorporated into the receiver when the oscillator incorporated into the receiver has a specified temperature; and
calculating, based on the estimated drift amount, the frequency of the reference frequency signal outputted from the oscillator incorporated into the receiver.

6. A non-transitory computer-readable storage medium storing a program comprising computer-executable instructions that cause a computer of a receiver, which receives a positioning satellite signal transmitted from a positioning satellite, to perform:
outputting, by an oscillator, a reference frequency signal used for down-converting the positioning satellite signal;
detecting, by a temperature sensor, temperature of the oscillator to provide a temperature data;
storing in a correction table storage a correction table indicating a correspondence between
a predetermined temperature and
a drift amount of a frequency of the reference frequency signal outputted from the oscillator unmounted in the receiver, wherein the drift amount stored in the correction table storage is an amount of change of a first frequency with respect to a second frequency, wherein the first frequency is the frequency of the reference frequency signal that is outputted from the oscillator unmounted in the receiver when the oscillator unmounted in the receiver has the predetermined temperature, wherein the second frequency is the frequency of the reference frequency signal that is outputted from the oscillator unmounted in the receiver when the oscillator unmounted in the receiver has a reference temperature;
storing in a frequency storage a specified frequency that is the frequency of the reference frequency signal that is outputted from the oscillator incorporated into the receiver when the oscillator incorporated into the receiver has a specified temperature;
estimating, by a processor, a drift amount of the frequency of the reference frequency signal outputted from the oscillator incorporated into the receiver, based on the temperature data detected with the temperature sensor, the correction table stored in the correction table storage, and the specified frequency stored in the frequency storage; and
calculating, by the processor, the frequency of the reference frequency signal outputted from the oscillator incorporated into the receiver, based on the estimated drift amount.
